(19) United States
(12) Patent Application Publication
(10) Pub. No.: US 2014/0266747 A1
(43) Pub. Date: Sep. 18, 2014

(54) SMOKE AND CARBON MONOXIDE DETECTOR ELECTRICALLY COUPLED TO A LIGHT SOURCE, AND POSITIONED IN A LIGHT FIXTURE

(71) Applicant: Cyril Patrick Prendergast, Hopewell Junction, NY (US)

(72) Inventor: Cyril Patrick Prendergast, Hopewell Junction, NY (US)

(21) Appl. No.: 14/210,368

(22) Filed: Mar. 13, 2014

Related U.S. Application Data
(60) Provisional application No. 61/792,726, filed on Mar. 15, 2013.

(51) Int. Cl. G08B 17/10

(52) U.S. Cl. CPC G08B 17/10
USPC 340/628; 362/253

(57) ABSTRACT

The present invention relates generally to a smoke and carbon monoxide detector paired and concealed within a light fixture. More particularly, the invention encompasses an apparatus where at least one smoke detector and at least one carbon monoxide detector are paired or coupled and are also positioned within a light fixture, and preferably inside a light fixture. The invention further comprises a paired or coupled smoke detector and carbon monoxide detector that are electrically coupled to a light bulb and are securely positioned inside a light fixture. The light source fixture may be coupled to a spring activated switch, the spring activated switch would be coupled to a smoke detector and a carbon monoxide detectors to test the presence of electrical power.

### CROSS-REFERENCE TO RELATED APPLICATION

The instant patent application claims priority to and the benefit of pending U.S. Provisional Patent Application Ser. No. 61/792,726, filed on Mar. 15, 2013, titled “A PAIRED SMOKE AND CARBON MONOXIDE DETECTOR, ELECTRICALLY CONNECTED TO A LIGHT BULB, AND SECURED INSIDE A LIGHT FIXTURE,” the entire disclosure of which provisional application is incorporated herein by reference.

### FIELD OF THE INVENTION

The present invention relates generally to a smoke and carbon monoxide detector paired and concealed within a light fixture. More particularly, the invention encompasses an apparatus where at least one smoke detector and at least one carbon monoxide detector are paired or coupled and are also positioned within a light fixture, and preferably inside a light fixture. The invention further comprises a paired or coupled smoke detector and carbon monoxide detector that are electrically coupled to a light bulb and are securely positioned inside a light fixture. The light source fixture may be coupled to a spring activated switch, the spring activated switch would be coupled to a smoke detector and a carbon monoxide detectors to test the presence of electrical power.

### BACKGROUND INFORMATION

Smoke detectors and carbon monoxide detector have been known and have been used for many years, and under a variety of applications.

U.S. Pat. No. 5,766,029 (Mark Raison) discloses a connector for attaching and mounting a first electrical device, such as a carbon monoxide detector (36) or a motion detector, to a second electrical device such as a smoke detector (34) or another source of electrical power premounted on the ceiling or wall. The connector comprises an elongated member defining spaced first and second apertures (18,28). At least a portion of the first aperture (18) may extend only partway through the elongated member to provide a back wall which is used for securing the connector to the wall or ceiling. The second aperture (28) extends completely through the elongated member, for receiving the preinstalled second electrical device (34). A channel (32) is defined in the elongated member extending between the first and second apertures, to provide an enclosed space for electric wire (38) to connect between the respective electrical devices mounted in the respective apertures.

U.S. Pat. No. 5,786,767 (Joseph Severino) discloses a home safety system comprising a smoke detector, a carbon monoxide detector and a microphone connected to a transmitter. The smoke detector is powerable by a/c current and by a battery, and comprises a sensor for sensing smoke connected to an audible alarm signal. The carbon monoxide detector is powerable by a/c current and by a battery and comprises a sensor for sensing the presence of carbon monoxide connected to an audible alarm signal. The transmitter comprises means for communicating signals from the carbon monoxide detector and smoke detector to a remote location. The invention further comprises an emergency lighting system connected to the carbon monoxide detector and smoke detector. The light system is powered by a battery and adapted to turn on in the event of a power failure, a signal from the smoke detector or a signal from the carbon monoxide detector. The lighting system can also be used as a night light. A portable receiver receives signals from the transmitter and broadcasts the signals to alert an individual monitoring the conditions to the presence of smoke or carbon monoxide.

U.S. Pat. No. 5,936,532 (David A. Peralta) discloses a smoke and carbon monoxide detector for mounting upon a wall, having a housing having a front face. A clock having clock hands and clock indicia is present on the front face. The detector comprises a smoke detector element, a carbon monoxide detector element, and has an annunciator which sounds upon the presence of smoke or carbon monoxide. A deactivation button allows the annunciator to be temporarily deactivated in the event of a clearly false warning. The deactivation button also initiates a timing operation so that the annunciator is automatically re-enabled at the end of a predetermined time interval.

U.S. Pat. No. 6,420,973 (James Acevedo) discloses a wireless detection system for monitoring a predetermined area for an emergency situation. The wireless smoke detection system includes a plurality of detector units strategically positioned throughout the monitored area. Each of the plurality of detector units include a detector for sensing one of a characteristic and condition within a section of the monitored area and generating a signal indicative of the monitored. A signal processor is connected within each detector unit for analyzing the signal generated by the detector and upon determining if the signal is above a predetermined level generating an emergency signal. A transmitter is provided for transmitting the emergency signal to a plurality of receiver units strategically positioned about the monitoring area. Each receiver unit includes an alarm for generating an alarm signal and thereby alert persons to the emergency situation at a position within the monitored area. The detector can be at least one of a photoelectric smoke detector, an ionization type detector, a combination carbon monoxide and smoke detector, a carbon monoxide detector, a near infrared detector and a hazard detector.

U.S. Pat. No. 8,077,046 (Jacob Wong) discloses a fire detector and method of using it generate a fire alarm through use of a smoke detector and a carbon monoxide detector once the smoke detector detects a threshold level of light obscuration for greater than a first pre-selected time period or a reduced threshold level of light obscuration for greater than a second pre-selected time period or the CO detector detects a rate of increase in CO concentration which exceeds a first preselected CO rate for a third pre-selected time period and the smoke detector detects the reduced threshold level of light obscuration or the rate of increase in CO concentration exceeds a second preselected CO rate for a fourth pre-selected time period. The fire detector and method can also use a carbon dioxide detector and generate the fire alarm when either a rate of increase in concentration of CO₂ exceeds a first CO₂ predetermined rate for a fifth pre-selected time period and the smoke detector detects a reduced threshold level of light obscuration or the rate of increase in concentration of CO₂ exceeds a second CO₂ predetermined rate for a sixth pre-selected time period.

This invention improves on the deficiencies of the prior art and provides an inventive paired smoke and carbon monoxide detector, electrically connected to a light bulb, and secured inside a light fixture.

### PURPOSES AND SUMMARY OF THE INVENTION

The invention is a novel smoke and carbon monoxide detector apparatus where the two different types of detectors are paired and also concealed or positioned within a fixture, such as a light fixture.

Therefore, one purpose of this invention is to provide a cost effective and durable smoke and carbon monoxide detector apparatus where the two different types of detectors are paired and are also concealed within a fixture, such as, a light fixture.

Another purpose of this invention is to provide a smoke and carbon monoxide detector apparatus where the two different types of detectors are paired and also concealed or positioned within a fixture such as a light fixture and where each detector is coupled to at least one battery backup system.

Another purpose of this invention is to provide a smoke and carbon monoxide detector apparatus where the two different types of detectors are paired and also concealed or positioned within a fixture, such as a light fixture and where each detector is electronically coupled to at least one alarm system.

Therefore, in one aspect this invention comprises an apparatus for providing light to an area and for detecting smoke and/or carbon monoxide comprising:

a housing:

a light source fixture adapted for holding a light source;

a smoke detector for detecting smoke and for generating a first signal;

a carbon monoxide detector for detecting a gas and for generating a second signal;
a junction box adapted for coupling to a source of electrical power coupled to said light source fixture, smoke detector, carbon monoxide detector for providing electrical power thereto and for receiving said first and second signals; and
an alarm system coupled to said junction box for receiving electrical power and said first and second signals for generating a third signal indicative of smoke or carbon monoxide in response to said first and second signals.

In another aspect this invention comprises an apparatus for providing light to an area and for detecting smoke andor carbon monoxide comprising:

a housing;
a light source fixture adapted for holding a light bulb;
a smoke detector for detecting smoke;
a carbon monoxide detector for detecting a gas;
a junction box adapted for coupling to a source of electrical power coupled to said light source fixture, smoke detector, carbon monoxide detector for providing electrical power thereto and for receiving signals from said smoke detector and said carbon monoxide detector; and
an alarm system coupled to said junction box for receiving electrical power and said signals from said smoke detector and said carbon monoxide detector for generating an alarm signal indicative of smoke and/or carbon monoxide.

In yet another aspect this invention comprises a paired smoke and carbon monoxide detector, electrically connected to a light bulb, and concealed within a light fixture.

### BRIEF DESCRIPTION OF THE DRAWINGS

Although the scope of the present invention is much broader than any particular embodiment, a detailed description of the preferred embodiment follows together with drawings. These drawings are for illustration purposes only and are not drawn to scale. Like reference numbers represent like features and components in the drawings. The invention may best be understood by reference to the ensuing detailed description in conjunction with the drawings in which:

FIG. 1 illustrates a first embodiment of an inventive fixture having a paired smoke and carbon monoxide detector and concealed within a light fixture.

FIG. 2 illustrates a second embodiment of an inventive fixture having a paired smoke and carbon monoxide detector and concealed within a light fixture.

FIG. 3 illustrates a third embodiment of an inventive fixture having a paired smoke and carbon monoxide detector and concealed within a light fixture.

FIG. 4 illustrates a fourth embodiment of an inventive fixture having a paired smoke and carbon monoxide detector and concealed within a light fixture.

FIG. 5 illustrates a fifth embodiment of an inventive fixture having a paired smoke and carbon monoxide detector and concealed within a light fixture.

FIG. 6 illustrates an electrical circuit diagram for a sixth embodiment of an inventive fixture having a paired smoke and carbon monoxide detector and concealed within a light fixture.

FIG. 7 illustrates an electrical circuit diagram for a seventh embodiment of an inventive fixture having a paired smoke and carbon monoxide detector and concealed within a light fixture.

FIG. 8 illustrates an electrical circuit diagram for an eight embodiment of an inventive fixture having a paired smoke and carbon monoxide detector and concealed within a light fixture.

FIG. 9 illustrates an electrical circuit diagram for a ninth embodiment of an inventive fixture having a paired smoke and carbon monoxide detector and concealed within a light fixture.

FIG. 10 illustrates an electrical circuit diagram for a tenth embodiment of an inventive fixture having a paired smoke and carbon monoxide detector and concealed within a light fixture.

### DETAILED DESCRIPTION

The embodiments of the present invention are described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

FIG. 1 illustrates a first embodiment of an inventive fixture having a paired smoke detector for detecting smoke and for generating a first signal and a carbon monoxide detector for detecting a gas and for generating a second signal. The paired smoke detector and carbon monoxide detector are concealed or positioned within a light fixture 23. Light fixture 23 comprises a housing 50 such as a high hat 50 shown in FIG. 1, within which a paired detector 10, comprising a smoke detector 12, and a carbon monoxide detector 14, are housed. Housing 50 also has at least one light source fixture 15, to accommodate at least one light source 45, such as, a light bulb, a fluorescent bulb, a light emitting diode (LED), to name a few. Light fixture 23, also has at least one junction box 5, that provides electrically connections to the paired detectors 10, namely, smoke detector 12, carbon monoxide detector 14, and light source 45, via light source fixture 15. Junction box 5 is adapted for coupling to a source of electrical power. Junction box 5 is coupled to light source fixture 15, smoke detector 12, carbon monoxide detector 14 for providing electrical power thereto and for receiving first and second signals from detectors 12 and 14. A test/reset button 25, a test indicating light 30, and a back-up battery 7, are also securely and electrically connected to housing 50. In a typical application housing 50 is inserted into a cavity or hole or blind hole 65, of ceiling or wall 60 and where the edges or lips 58 of housing 50, are in flush or surface contact with a surface 68, of ceiling or wall 60. For some applications a sealing gasket or a weather insulating gasket 59, may be provided to further provide an environmental seal between the edge or lip 58, and surface 68, of the wall or ceiling 60. Optionally, the paired detector 10, could also have a test or reset button 25, and/or a test indicating light 30, such as an LED light, to indicate that power is present. For some applications in order to test the paired detector 10, one would push up gently on light source or its lens 45 to engage and switch a spring activated switch mechanism 55 which is coupled in parallel with the test/reset button 25. Light source fixture 15, holding light source 45, is coupled to a spring activated switch 55, said spring activated switch 55, coupled to said smoke detector 12, and said carbon monoxide detector 14, to test the presence of electrical power.

FIG. 2 illustrates a second embodiment of an inventive fixture having a paired smoke and carbon monoxide detector and concealed within light fixture 33, or a paired detector in light fixture 33. Light fixture 33, has a junction box 5, that provides electrical connections to paired detector 10, namely, smoke detector 12, and carbon monoxide detector 14, and light bulb 45 in a light fixture 15. A test/reset button 25, a test indicating light 30, and a back-up battery 7, is also provided coupled to junction box 5. Light fixture 33, further comprises a second paired detector 20, namely, a second smoke detector 22, and a second carbon monoxide detector 24, that are electrically coupled to junction box 5, but is at another location, such as, a different room, different floor, etc. The second paired detector 20, namely, smoke detector 22, and carbon monoxide detector 24, may be positioned inside housing 51, and they could be paired with a light bulb 45, (not shown) or it could be a separate second paired detector 20, namely, a smoke detector 22 and a carbon monoxide detector 24, operating in a stand-alone manner, but paired together using housing 51. Optionally, the paired detector 10, 20, could also have a test/reset button 25, and/or a test indicating light 30, such as an LED light, to indicate that power is present. Optionally, in order to test paired detector 10, 20, one would push up gently on the light source 45 or its lens, and this pressure or movement would effectively activate test/reset button 25, via a spring activated switch mechanism 55 coupled in parallel to test/reset button 25.

FIG. 3 illustrates a third embodiment of an inventive fixture having a paired smoke and carbon monoxide detector positioned within light fixture 43, or a paired detector in light fixture 43. Light fixture 43, has a junction box 5, that provides electrically connections to paired detector 10, namely, smoke detector 12, and carbon monoxide detector 14, and light bulb 45, that has light fixture 15. Test/reset button 25, and a test indicating light 30 is also provided. Light fixture 43, could also has at least one central or main back-up system 8, that is electrically connected to the junction box 5 via wiring 41. For some applications, light fixture 43, could also have at least one alarm system 40, that is electrically coupled to junction box 5 via wiring 47. Alarm system 40 is coupled to junction box 5 for receiving electrical power and first and second signals from detectors 12 and 14 for generating a third signal indicative of smoke or carbon monoxide in response to the first and second signals.

FIG. 4 illustrates a fourth embodiment of an inventive fixture having a paired smoke and carbon monoxide detector and concealed within a light fixture 53, or a paired detector in a light fixture 53. Light fixture 53, has a junction box 5, that provides electrical connections to paired detector 10, namely, the smoke detector 12, and the carbon monoxide detector 14, and light bulb 45, having light fixture 15. A test/reset button 25, a test indicating light 30, and a back-up battery 7, may also be provided. Light fixture 53, further comprises a second paired detector 20, namely, a smoke detector 22, and a carbon monoxide detector 24, that are electrically connected to junction box 5, but is at another location, such as, a different room, different floor, etc. Second paired detector 20, namely, the smoke detector 22, and the carbon monoxide detector 24, may be concealed inside a housing 51, and electrically coupled to a light bulb 45, (not shown) or be a separate second paired detector 20, namely, a smoke detector 22, and a carbon monoxide detector 24, operating in a stand-alone manner. Optionally, light fixture 53, could also have at least one central or main back-up system 8, that is electrically connected to junction box 5, via wiring 41. For some applications, light fixture 43 could also have at least one alarm system 40 that is electrically connected to the junction box 5, via wiring 47. For some applications, at least one alarm system 40 could also be electrically coupled to second paired detector 20 via wiring 49.

FIG. 5 illustrates a fifth embodiment of an inventive fixture having a paired smoke and carbon monoxide detector and concealed within a light fixture 63, or a paired detector in a light fixture 63. Light fixture 63, has a junction box 5, that provides electrically connections to paired detector 10, namely, the smoke detector 12, and the carbon monoxide detector 14, and light bulb 45, having light fixture 15. A test/reset button 25, and a test indicating light 30 is also provided. Light fixture 63, has at least one warning light system 35. The warning light system 35, preferably could have a flasher or a flicker 35, which once activated would turn ON and OFF to indicate that an alarm has been triggered, and this would be very helpful, especially to hearing impaired individuals. For some applications, light fixture 63, could also have at least one central or main back-up system 8, that is electrically connected to the junction box 5, via wiring 41.

FIG. 6 illustrates an electrical circuit diagram for a sixth embodiment of an inventive fixture having a paired smoke and carbon monoxide detector and concealed within a light fixture 23, or a paired detector in a light fixture 23. Light fixture 23 has a junction box 5, that provides electrically connections to the paired smoke and carbon monoxide detector 10, and light bulb 45 via light fixture 15. A test/reset button 25, a test indicating light 30, and a back-up battery 7, is also provided. FIG. 6 shows interconnection wiring with wires labeled one of W, B, and G which carry or distribute electrical power to and between units such as junction box 5, light source fixture 15, light source 45, smoke and carbon monoxide detector 10, test/reset button 25 and test indicating light 30. W stands for white wires, B stand for black wires, and G stands for green wires. Green wires are normally neutral, while white and black wires carry electrical current.

FIG. 7 illustrates an electrical circuit diagram for a seventh embodiment of an inventive fixture having a paired smoke and carbon monoxide detector positioned within a light fixture 33, or a paired detector in a light fixture 33. The inventive fixture 33, has a junction box 5, that provides electrical connections to paired smoke and carbon monoxide detector 10, and light bulb 45 via light fixture 15. A test/reset button 25, a test indicating light 30, and a back-up battery 7, is also provided. Light fixture 33, further comprises a second paired smoke and carbon monoxide detector 20, that is electrically connected to the junction box 5, but is at another location, such as, a different room, different floor, etc. Second paired smoke and carbon monoxide detector 20, may be positioned inside light fixture 15, and coupled to light bulb 45, (not shown) or be a separate second paired smoke and carbon monoxide detector 20 operating in a stand-alone manner. FIG. 7, shows interconnection wiring with wires labeled one of W, B, and G which carry or distribute electrical power to and between units. W stands for white wires, B stand for black wires, and G stands for green wires. Green wires are normally neutral, while white and black wires carry electrical current.

FIG. 8 illustrates an electrical circuit diagram for an eight embodiment of an inventive fixture having a paired smoke and carbon monoxide detector and concealed within a light fixture 43, or a paired detector in a light fixture 43. Light fixture 43 has a junction box 5, that provides electrical connections to paired smoke and carbon monoxide detector 10, and light bulb 45 via the light fixture 15. A test/reset button 25 and a test indicating light 30 is also provided. Light fixture 43 has an alarm system 40 and a central or main back-up system 8. FIG. 8 shows interconnection wiring with wires labeled one of W, B, and G which carry or distribute electrical power to and between units. W stands for white wires, B stand for black wires, and G stands for green wires. Green wires are normally neutral, while white black wires carry electrical current.

FIG. 9 illustrates an electrical circuit diagram for a ninth embodiment of an inventive fixture having a paired smoke and carbon monoxide detector and concealed within a light fixture 53, or a paired detector in a light fixture 53. Light fixture 53 has a junction box 5, that provides electrical connections to the paired smoke and carbon monoxide detector 10, and light bulb 45 via the light fixture 15. A test/reset button 25, a test indicating light 30, and a back-up battery 7, is also provided. Light fixture 53 further comprises a second paired smoke and carbon monoxide detector 10, that is electrically connected to the junction box 5, but is at another location, such as, a different room, different floor, etc. The second paired smoke and carbon monoxide detector 10, may be positioned inside light fixture IS, and paired with light bulb 45, (not shown) or be a separate second paired smoke and carbon monoxide detector 10, operating in a stand-alone manner. Light fixture 53, has an alarm system 40, and a central or main back-up system 8. FIG. 9 shows interconnection wiring with wires labeled one of W, B, and G, which carry or distribute electrical power to and between units. W stands for white wires, B stand for black wires, and G stands for green wires. Green wires are normally neutral, while white and black wires carry electrical current. A Y label stands for a yellow wire, which is neutral or carries electrical current between detectors 10.

FIG. 10 illustrates an electrical circuit diagram for a tenth embodiment of an inventive fixture having a paired smoke and carbon monoxide detector and concealed within a light fixture 63, or a paired detector in a light fixture 63. The inventive fixture 63, has a junction box 5, that provides electrically connections to the paired smoke and carbon monoxide detector 10, and light bulb 45 via light fixture 15. A test/reset button 25, and a test indicating light 30 is also provided. Light fixture 63 has a central or main back-up system 8 and a warning light system 35. The light warning system 35, preferably would have a flasher or a flicker 35, which once activated would turn on and off to indicate that an alarm has been triggered, and this would be very helpful, especially to hearing impaired individuals. FIG. 10 shows interconnection wiring with wires labeled one of W, B, and G, which carry or distribute electrical power to and between units. W stands for white wires, B stand for black wires, and G stands for green wires. Green wires are normally neutral, while white and black wires carry electrical current.

It is preferred that the paired detectors 10, 20, will not be visible to the eye, i.e., that they will be either mounted inside housing 50, 51, or that they would be flush or surface mounted in the wall or ceiling 60, such that they do not protrude too much out of the surface 68, of the wall or ceiling 60. The flush or surface mounting of light fixtures 23, 33, 43, 53, 63, would help with the continuity of the ceiling or wall layout. The concealment of paired detectors 10, 20, will also eliminate the usual eye-sore of smoke detector 12, and carbon monoxide detector 14 that appears when they individually or separately protrude out, such as from ceiling or wall 60, such as a vertical wall 60.

It should be appreciated that paired detectors 10, 20, will function as a regular smoke detector 12, 22, and a carbon monoxide detector 14, 24. Preferably, smoke detector 12, 22, and carbon monoxide detector 14, 24 will have a test/retest button 25, and/or a test indicating light 30. Paired detector 10 will also have the ability to interconnect with all other detectors 10, 20, in the home or building or at a second location separate from the first location.

It should be appreciated that the paired detectors 10, 20, will have the ability to electrically connect to at least one back-up battery system 8. It is preferred that the paired detectors 10, 20, in the house, office, or at any other location are able to be connected to at least one back-up system 8. These paired light fixtures 23, 33, 43, 53, 63, can also have their own individual back-up battery 7, thus eliminating the need to wire the whole house or office or location. As stated earlier that this inventive system 23, 33, 43, 53, 63, should be able to hook-up to at least one alarm system 40.

The paired detectors 10, 20, would preferably be electrically connected to at least one light flasher or flicker 35, which would turn ON and OFF, and which would be separate from the other lights in the room or location to warn people, such as, a hearing impaired person, that an alarm is going OFF, or an alarm has been activated.

Thus, the present invention is not limited to the embodiments described herein and the constituent elements of the invention can be modified in various manners without departing from the spirit and scope of the invention. Various aspects of the invention can also be extracted from any appropriate combination of a plurality of constituent elements disclosed in the embodiments.

Still further, while certain embodiments of the invention have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. Apparatus for providing light to an area and for detecting smoke and/or carbon monoxide comprising:
a housing;
a light source fixture adapted for holding a light source;
a smoke detector for detecting smoke and for generating a first signal;
a carbon monoxide detector for detecting a gas and for generating a second signal;
a junction box adapted for coupling to a source of electrical power coupled to said light source fixture, smoke detector, carbon monoxide detector for providing electrical power thereto and for receiving said first and second signals; and
an alarm system coupled to said junction box for receiving electrical power and said first and second signals for generating a third signal indicative of smoke or carbon monoxide in response to said first and second signals.

2. The apparatus of claim 1 wherein said light source fixture is coupled to a spring activated switch, said spring activated switch coupled to said smoke and carbon monoxide detectors to test the presence of electrical power.

3. The apparatus of claim 1 further including a back-up battery coupled to said junction box.

4. The apparatus of claim 1 further including a back-up power system coupled to said junction box.

5. The apparatus of claim 1 further including an alarm system coupled to said junction box.

6. The apparatus of claim 1 further including a test/reset button and a test indicating light coupled to said junction box.

7. The apparatus of claim 1 further including a test/reset button and a test indicating light coupled to said smoke detector.

8. The apparatus of claim 1 further including a warning light system coupled to said junction box.

9. The apparatus of claim 1 further including a battery coupled to said smoke detector.

10. The apparatus of claim 1 further including an alarm system coupled to said smoke and carbon monoxide detectors.

11. The apparatus of claim 1 wherein said apparatus further includes a light source positioned in said light source fixture selected from the group consisting of a light bulb, fluorescent bulb and light emitting diode.

12. Apparatus for providing light to an area and for detecting smoke and/or carbon monoxide comprising:
a housing;
a light source fixture adapted for holding a light bulb;
a smoke detector for detecting smoke;
a carbon monoxide detector for detecting a gas;
a junction box adapted for coupling to a source of electrical power coupled to said light source fixture, smoke detector, carbon monoxide detector for providing electrical power thereto and for receiving signals from said smoke detector and said carbon monoxide detector; and
an alarm system coupled to said junction box for receiving electrical power and said signals from said smoke detector and said carbon monoxide detector for generating an alarm signal indicative of smoke and/or carbon monoxide.

13. The apparatus of claim 12 wherein said light source fixture is coupled to a spring activated switch, said spring activated switch coupled to said smoke and carbon monoxide detectors to test the presence of electrical power.

14. The apparatus of claim 12 further including a back-up power system coupled to said junction box.

15. The apparatus of claim 12 further including an alarm system coupled to said junction box.

16. The apparatus of claim 12 further including an alarm system coupled to said smoke and carbon monoxide detectors.

17. The apparatus of claim 12 further including a test/reset button and a test indicating light coupled to said junction box.

18. The apparatus of claim 12 further including a test/reset button and a test indicating light coupled to said smoke detector.

19. The apparatus of claim 12 wherein said apparatus further includes a light source positioned in said light source fixture selected from the group consisting of a light bulb, fluorescent bulb or light emitting diode.

20. A paired smoke and carbon monoxide detector, electrically connected to a light bulb, and concealed within a light fixture.
